(19) United States
(12) Patent Application Publication
(10) Pub. No.: US 2013/0299759 A1
(43) Pub. Date: Nov. 14, 2013

(54) SYSTEM AND METHOD FOR PREVENTING VEHICLE THEFT

(71) Applicants: Gabriel Sezanayev, Flushing, NY (US); Akhmad Turaev, Flushing, NY (US)

(72) Inventors: Gabriel Sezanayev, Flushing, NY (US); Akhmad Turaev, Flushing, NY (US)

(21) Appl. No.: 13/466,799

(22) Filed: May 8, 2012

(51) Int. Cl. B60S 9/02

(52) U.S. Cl. 254/418

(57) ABSTRACT

A system for preventing a vehicle theft has vehicle having wheels, and means for lifting the vehicle when it is left by an owner or a driver so that the wheels are located above a ground so that a thief cannot driver or move the vehicle with the wheels in contact with the ground.

### BACKGROUND OF THE INVENTION

The present invention relates to systems and methods for preventing a theft of vehicle.

Some systems and methods for theft preventing are known. They include for example means for preventing an unauthorized ignition of a vehicle engine, locking means which lock a steering wheel to prevent its turning, locks placed on pedals to block their activation, etc.

It is believed that existing systems and methods can be further improved so as to simplify activation of the system and to increase reliability of the theft preventions.

### SUMMARY OF THE INVENTION

It is therefore an object of the present invention to provide a system and method for preventing vehicle theft, which is a further improvement of the known systems and methods.

In keeping with these objects and with others which will become apparent hereinafter, one feature of the present invention resides, briefly stated, in a system for preventing a vehicle theft, comprising a vehicle having wheels; and means for lifting the vehicle when it is left by an owner or a driver so that the wheels are located above a ground so that a thief cannot driver or move the vehicle with the wheels in contact with the ground.

Another feature of the present invention is that said means said means is configured so that when the owner or the driver of the vehicle stops the vehicle and of the vehicle turns off its engine, said means automatically extend lifting members which lift the vehicle so that the wheels are located above the ground.

Still another feature of the present invention is that said means is configured so that the owner or the driver of the vehicle can activate said means and said means extend lifting members which lift the vehicle so that the wheels are located above the ground.

A further feature of the present invention is that wherein the vehicle has elements for smoothing vertical vibrations of the vehicle during driving, said means being configured to act of said smoothing elements to use of at least a part of the latter for lifting the vehicle so that the wheels are located above the ground.

Still a further feature of the present invention is that wherein said means is configured so that it provide lifting of the vehicle so that the wheels are located above the ground at a first height to prevent driving or moving the vehicle to prevent theft, and also lifting of the vehicle so that the wheels are located above the ground at a second height which allows changing of tires.

An additional feature of the present invention is that said means is configured so that said means extend independently one of a plurality of a lifting members to lift a part of the vehicle allowing to change a respective ones of the tires.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side view of a vehicle provided with a system for theft prevention operating in accordance with the inventive theft prevention method;

FIG. 2 is a view from below of a vehicle showing the location of lifting members of the inventive system and method;

FIG. 3 is a schematic view of components of the inventive theft preventing system;

FIG. 4 is a schematic view showing another embodiment of the inventive theft preventing system;

FIG. 5 is a view showing one embodiment of lifting elements of the inventive system; and

FIG. 6 is a view showing another embodiment of the lifting elements of the inventive system.

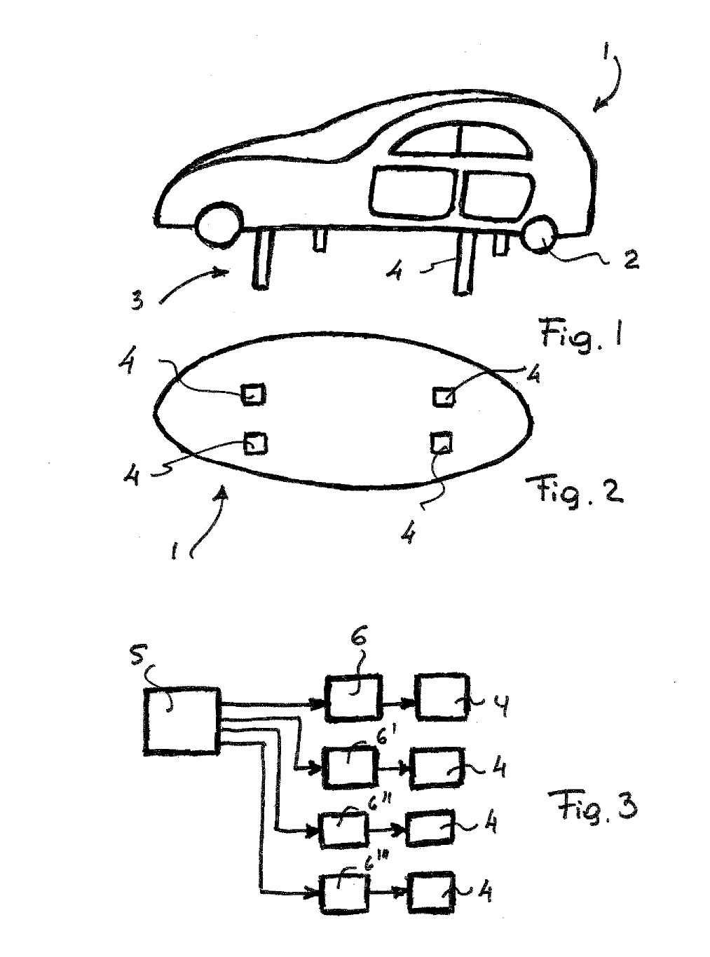

### DESCRIPTION OF THE PREFERRED EMBODIMENTS

The inventive system for preventing a vehicle theft operating in accordance with the inventive method includes a vehicle which is identified with reference numeral 1 and has a plurality of wheels 2.

In accordance with the present invention the system has means 3 for lifting the vehicle when it is left by an owner or a driver so that the wheel are located above the ground and a thief cannot drive or move the vehicle 1 with the wheels in contact with the ground. The means 3 can include at least three lifting members 4, preferably 4 lifting members 4.

The lifting members 4 can be connected to any part of the vehicle 1 on its underside, for example to the frame of the vehicle 1. When the lifting members are retracted upwardly, the vehicle 1 can stand on a ground with its wheels 2 in contact with the ground.

In accordance with the present invention the lifting members 4 are extended downwardly so that the vehicle 1 is lifted and its wheels 2 are located above the ground with a gap between the wheels 2 and the ground. As a result, a thief cannot drive or move the vehicle 1 with its wheels in contact with the ground.

In accordance with one embodiment of the invention an engine 5 of the vehicle 1 is electrochemically connected with activation units 6, 6′, 6″, 6′″ which extend and retract the wheels 4. Any electrical, electronic, mechanical and other devices can be used as the activation unit. In accordance with the present invention when the engine 5 is turned off, a signal is sent automatically through wires or wirelessly, to the activation units, and the activations units extend the lifting members 4 to lift the vehicle 1 and to space the wheels 2 from the ground.

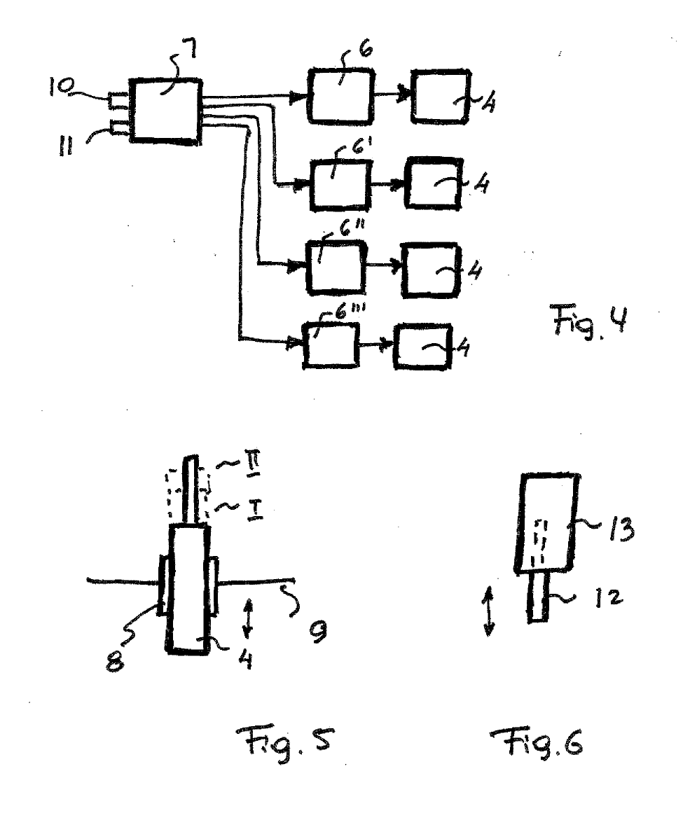

FIG. 4 schematically shows another embodiment of the present invention. In this embodiment of the owner or the driver of the vehicle uses a signal generator 7. When he/she activates the signal generator 7, the signal generator send through wires or wirelessly a signal to the activation units 6, 6′, 6″, 6′″, and the activation units response to the signal extend the lifting members 4.

FIG. 5 shows one of the lifting members 4. The lifting member 4 can be arranged vertically displaceably in a guide 8 which is mounted in a frame 9 of the vehicle 1 and can be provided with an end part formed for example as an end rod 9. The lifting member 4 can be formed a plunger of a sufficiently thickness and strength. The lifting member 4 is retracted and extended by acting on the rod 9.

In accordance with another feature of the present invention, the lifting members 4 can be extended to position I to lift the wheels 2 to a first height to prevent theft of the vehicle, and also alternatingly they can be extended to position II to lift the wheels to a second height to allow change of tires on the wheels 4. This can be achieved by two different activating buttons 10 and 11 on the signal generator 7. On the hand, the distance of extension of the lifting members can be adjusted not only discretely to 2 positions, but uninterrupted to a plurality of positions.

FIG. 6 shows another embodiment of the lifting members. In this embodiment the lifting members 4 are parts of existing vertical vibration smoothing units, such as mechanical, hydraulic or pneumatic which shock absorbers. The movable parts 12 of shock absorbers 13 can be additionally extended further, so as to lift the wheels above the ground to prevent a vehicle theft or to allow a tire change.

In order to allow a change of one of the tires, it is possible, in accordance with the present invention, to extend the lifting member in the part of the vehicle located near this tire, so as to lift this particular part of the vehicle for the tire change.

It will be understood that each of the elements described above, or two or more together, may also find a useful application in other types of constructions and methods differing from the type described above.

While the invention has been illustrated and described as embodied in a system and method for preventing vehicle theft, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for preventing a vehicle theft, comprising a vehicle having wheels; and means for lifting the vehicle when it is left by an owner or a driver so that the wheels are located above a ground so that a thief cannot driver or move the vehicle with the wheels in contact with the ground.

2. A system as defined in claim 1, wherein said means is configured so that when the owner or the driver of the vehicle stops the vehicle and of the vehicle turns off its engine, said means automatically extend lifting members which lift the vehicle so that the wheels are located above the ground.

3. A system as defined in claim 1, wherein said means is configured so that the owner or the driver of the vehicle can activate said means and said means extend lifting members which lift the vehicle so that the wheels are located above the ground.

4. A system as defined in claim 1, wherein the vehicle has elements for smoothing vertical vibrations of the vehicle during driving, said means being configured to act of said smoothing elements to use of at least a part of the latter for lifting the vehicle so that the wheels are located above the ground.

5. A system as defined in claim 1, wherein said means is configured so that it provide lifting of the vehicle so that the wheels are located above the ground at a first height to prevent driving or moving the vehicle to prevent theft, and also lifting of the vehicle so that the wheels are located above the ground at a second height which allows changing of tires.

6. A system as defined in claim 5, wherein said means is configured so that said means extend independently one of a plurality of a lifting members to lift a part of the vehicle allowing to change a respective ones of the tires.

7. A method for preventing a vehicle theft, comprising the steps of a vehicle having wheels; and means for lifting the vehicle when it is left by an owner or a driver so that the wheels are located above a ground so that a thief cannot driver or move the vehicle with the wheels in contact with the ground.

8. A method as defined in claim 7, wherein said means is configured so that when the owner or the driver of the vehicle stops the vehicle and of the vehicle turns off its engine, said means automatically extend lifting members which lift the vehicle so that the wheels are located above the ground.

9. A method as defined in claim 7, wherein said means is configured so that the owner or the driver of the vehicle can activate said means and said means extend lifting members which lift the vehicle so that the wheels are located above the ground.

10. A method as defined in claim 7, wherein the vehicle has elements for smoothing vertical vibrations of the vehicle during driving, said means being configured to act of said smoothing elements to use of at least a part of the latter for lifting the vehicle so that the wheels are located above the ground.
